(19) United States
(12) Patent Application Publication
(10) Pub. No.: US 2023/0161688 A1
(43) Pub. Date: May 25, 2023

(54) INTELLIGENT TEST METHOD FOR DYNAMICALLY GENERATING TEST CASE ACCORDING TO TEST PERFORMANCE OF TESTED SYSTEM

(71) Applicant: ZHEJIANG LAB, Hangzhou (CN)

(72) Inventors: Wei HUA, Hangzhou (CN); Yizheng CHEN, Hangzhou (CN); Gang HUANG, Hangzhou (CN); Rui CHI, Hangzhou (CN)

(21) Appl. No.: 17/987,888

(22) Filed: Nov. 16, 2022

(30) Foreign Application Priority Data
Nov. 24, 2021 (CN) 202111405653.4

(51) Int. Cl. G06F 11/36; G06K 9/62

(52) U.S. Cl. CPC G06F 11/3684; G06F 11/3688; G06K 9/6256

(57) ABSTRACT

An intelligent test method for dynamically generating a test case according to test performance of a tested system. According to the method, n simulation training cases are generated, and the performances of tested agents in the n cases are obtained by testing. By constructing a plurality of decision trees, the algorithm can accurately predict the performances of trained agents in different cases, and learn the spatial division of variables that will lead to different results in the simulation tests, so that the cases can be generated more accurately and effectively in the next round of testing. The method is simple and universal, appropriate for virtual simulation training in various scenes, and thereby improves the effectiveness of case generation in intelligent tests.

### CROSS-REFERENCE TO RELATED APPLICATIONS

The present application claims priority to Chinese Patent Application No. 202111405653.4, filed on Nov. 24, 2021, the content of which is incorporated herein by reference in its entirety.

### TECHNICAL FIELD

The present disclosure relates to the field of automatic driving simulation training, in particular to an intelligent test method for dynamically generating a test case according to test performance of a tested system.

### BACKGROUND

Compared with the training in real scenes, simulation is more efficient and low-cost, so it is widely used in the process of training system. Case generation, as an important link, can facilitate training of various situations that the tested system may encounter in the simulation environment, and simulating unusual special situations to improve the training efficiency. In order to test the performance of the system under test in various scenarios, the existing case generation methods cover various real situations by generating a large number of cases, but this method requires higher requirements for computing power and time cost. How to dynamically generate effective cases more intelligently according to the existing performance of an automatic training system is an urgent problem to be solved.

### SUMMARY

In view of the shortcomings of the prior art, the present disclosure provides an intelligent test method for dynamically generating test cases according to the test performance of a tested system. The method takes into account the performance of the trained agent in the previous test cases in the simulation, and dynamically generates the cases that are more in line with the test requirements according to the test results.

The purpose of the present disclosure is realized by the following technical solution:

An intelligent test method for dynamically generating test cases according to the test performance of a tested system comprises following steps:

S1, selecting a test template test_case_template containing N variables var.

S2, sampling values in a value range of each variable var, and forming a sampling set Q with all of the sampled values.

S3, selecting a value from a sampling set Q corresponding to each variable to form a template variable numerical sampling vector g=(s₁, s₂, . . . , s_{N}), s₁∈Q₁, s₂∈Q₂, . . . , s_{N}∈Q_{N}, and then generating a set G_init from g.

S4, starting a k^{th} round of test, wherein when k=1, the set Gₖ=G_init; traversing each template variable numerical sampling vector in the set Gₖ, obtaining a category label(g) corresponding to each template variable numerical sampling vector g according to the test template when traversing, and obtaining a test performance data set Dₖ corresponding to the set Gₖ.

S5, determining whether k is equal to 1. If k=1, training a decision tree Tₖ whose classification error rate is less than a preset threshold epsilonₖ by the test performance data set Dₖ, predicting the label(g) by the decision tree Tₖ according to any g; and putting a sample with wrong classification into a data set Dₖ₊₁. If k>1, classifying and verifying the samples in the test performance data set Dₖ by using decision trees T₁, T₂, . . . , Tₖ₋₁, and carrying out weighted average on a classification result of each sample for each decision tree to calculate an error rate. If the error rate is greater than or equal to a preset threshold epsilonₖ₋₁, training a decision tree Tₖ by the test performance data set Dₖ, predicting the label(g) by the decision tree Tₖ according to any g, putting the samples with wrong classification into the data set Dₖ₊₁ and going to S6. If the error rate is less than the preset threshold epsilonₖ₋₁, ending testing the test template test_case_template;

S6, finding all areas in which the classification label of g is predicted to be the first class by Tₖ in a N-dimensional space where g is located according to all leaf nodes classified as a first class in Tₖ, and taking a union of the areas, wherein the union is denoted as Rₖ;

S7, sampling a batch of new vectors g_new in the N-dimensional space where g is located, keeping a vector distribution density positively correlated with a distance between g_new and a boundary of Rₖ; forming a set G_new by g_new, letting k=k+1, if k is less than a threshold of preset rounds threshold, letting Gₖ=G_new, going to S4, and starting a next round of testing; otherwise, ending testing the test template test_case_template.

Further, in S4, in order to obtain the data set Dₖ corresponding to the set Gₖ, first, a copy of the test template test_case_template is generated, the varᵢ in the copy is replaced by sᵢ in g, and the replaced copy of the test template is defined as a test case and denoted as H(g); the tested system is tested with H(g) to obtain a test score score(g), and then a two-class category label(g) for the test case H(g) is provided according to the score(g), and finally, a binary group (g, label(g)) is put into the test performance data set Dₖ.

Further, the step of keeping a vector distribution density positively correlated with a distance between g_new and a boundary of the area R in S7 is specifically that the vector in G_new satisfying the following conditions:

(1) The closer to the boundary of Rₖ is, the denser the vector distribution is.

(2) A certain distance exists between a newly sampled vector and a tested vector.

Further, the distance between the newly sampled vector g_new and the tested vector g_old satisfies:

An absolute value of projection of g_new−g_old in the j dimension is greater than or equal to dⱼₖ, where g_old is an arbitrary vector belonging to the union of G₁, G₂, . . . , Gₖ, and dⱼₖ is the threshold of the distance between g_new and g_old in the j dimension in the k^{th} round.

Further, the category label(g) is LOW or NORMAL, the category label(g) is LOW when the test score(g) is less than a preset score threshold, and the category label(g) is NORMAL when the test score(g) is greater than or equal to the preset score threshold.

Further, dⱼₖ satisfies the following condition:

dⱼₖ=alpha*dⱼₖ₋₁

where alpha is a given normal number, 0<alpha<1.

The present disclosure has the following beneficial effects:

In the simulation process, the present disclosure makes full use of the results of previous test cases, and by constructing a plurality of decision trees, the algorithm can accurately predict the performances of trained agents in different cases, and learn the spatial division of variables that will lead to different results in the simulation test. According to this spatial division, the case distribution characteristics of the next stage are set to improve the effectiveness of case generation and training efficiency. In addition, the whole process can be iterated online in real time, and the update of the decision tree is completed in parallel with the case test. At this time, this method can significantly improve the efficiency of simulation training, and it is universal and suitable for simulation case testing in various scenarios, and excellent performance can be obtained in many application scenarios that need virtual simulation training.

### BRIEF DESCRIPTION OF DRAWINGS

FIG. 1 is a flow chart of an intelligent test method for dynamically generating test cases according to the test performance of a tested system.

### DESCRIPTION OF EMBODIMENTS

The purpose and effect of the present disclosure will become more apparent from description of the present disclosure in detail according to the following drawings and preferred embodiments. It should be understood that the specific embodiments described here are only for explaining the present disclosure, but not for limiting the present disclosure.

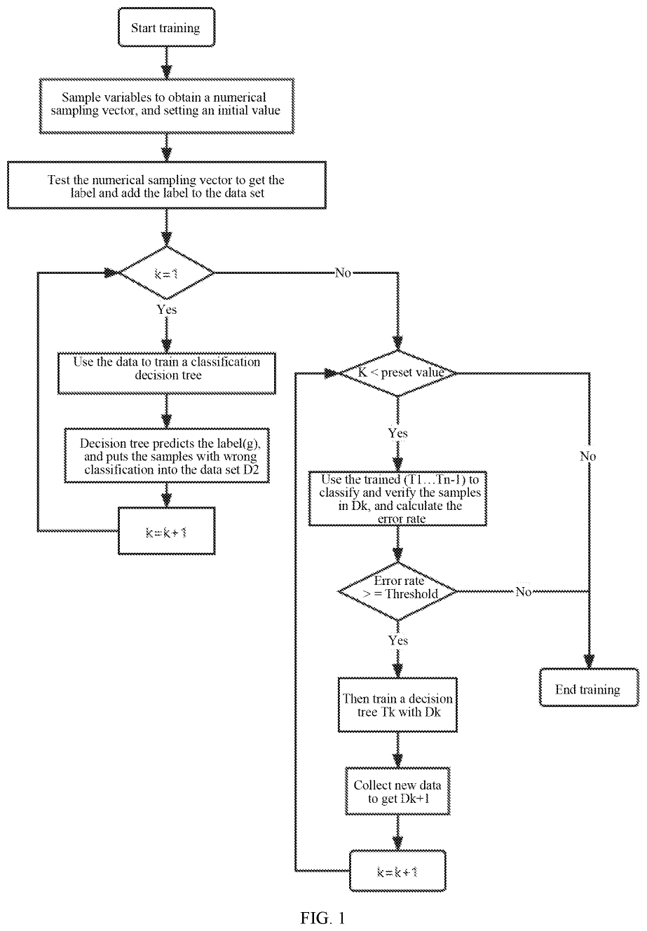

The method of the present disclosure as shown in FIG. 1 is applied to the simulation test process of autonomous driving virtual reality, so as to realize the intelligent test of dynamically generating cases according to the test performance of the tested system. In such a scenario, this embodiment specifically includes the following steps:

S1, among the cases that are prone to accidents in automatic driving, a test template case test_case_template was selected for the tested automatic driving agent vehicle to overtake the preceding vehicle. The test template contained six variables Var={A_x, A_y, A_v, B_x, B_y, B_v}, where (A_x, A_y) is the current coordinate of the tested agent vehicle with a unit of m; A_v is the current speed of the measured vehicle with a unit of km/h; (B_x, B_y) is the coordinate unit of the preceding vehicle of a unit of m; B_v is the speed of the preceding vehicle with a unit of km/h.

Each variable has a definite value range: A_x belongs to [2,4], A_y belongs to [0,3], B_x belongs to [1,5], B_y belongs to [4,10], A_v belongs to [30,50] and B_v belongs to [30,60].

S2, values were sampled for 100 times in the value range for each variable var, variables were evenly distributed in the value range thereof during sampling, and a sampling set Q is formed with all the sampled values of each variable var.

S3, a value was selected from a sampling set Q corresponding to each variable; a vector g was obtained after each time of sampling, and then a set G_init={g₁, g₂, . . . g₁₀₀} was generated from g, where gᵢ is called a template variable numerical sampling vector, and the value of the j^{th} dimension of gᵢ corresponds to the numerical sampling of the j^{th} variable.

S4, the k^{th} round of test was started. When k=1, the set Gₖ=G_init; dₖ is the threshold value of the distance between g and g_old in the k^{th} round, d₁=0.1. When k>1, dₖ=0.9dₖ₋₁, and the preset threshold of the error rate epsilon=0.1.

Each template variable numerical sampling vector in the set Gₖ was traversed, and the category label label(g) corresponding to each template variable numerical sampling vector g was obtained according to the test template in the traversal process, and the test performance data set Dₖ corresponding to the set Gₖ was obtained. The specific operation was as follows:

(1) A copy of test_case_template of autopilot was generated, varᵢ in the copy was replaced with sᵢ in G. The test template copy after replacement is called as a test case and denoted as H(g).

(2) The tested system was tested with H(g) to get a test score score(g), and then a two-class category label(g) was provided for the test case H(g) according to the score(g). In an embodiment, the category label(g) was LOW or NORMAL. When the test score(g) was less than the preset score threshold, the category label(g) was LOW, and when the test score(g) was greater than or equal to the preset score threshold, the category label(g) was NORMAL.

(3) The binary group (g, label(g)) was put into the test performance data set Dₖ.

In the embodiment of automatic driving, the i^{th} dimension numerical sampling gᵢ^{j} in gᵢ was used to replace the i^{th} template variable varᵢ in the test template copy, where i=1, 2, . . . , N. The test template copy after replacement is called an automatic driving test case and denoted as H(gᵢ), where H represents the mapping relationship from the template variable numerical sampling vector to the generated test case. The system under test was tested by the automatic driving test case H(gᵢ), and the test score of the agent unmanned vehicle was score(gᵢ). Then, a test result label label(gᵢ) was set for the test case H(g) according to score(gᵢ). The rules for setting the classification label were as follows: if score(gᵢ) was less than 60, then label(gᵢ) was set to low performance LOW, and if score(gᵢ) was in a range of [60,100], then label(gᵢ) was set as normal performance NORMAL, and the binary group (gᵢ, label(gᵢ)) was put into the test performance data set Dₖ.

S5, whether k is equal to 1 was determined. If k=1, Dₖ was used to train a decision tree Tₖ whose classification error rate is less than the preset threshold epsilonₖ, the label(g) was predicted by the decision tree Tₖ according to any g, and sample with wrong classification was put into the data set Dₖ₊₁. If k>1, decision trees T₁, T₂, . . . , Tₖ₋₁ were used to classify and verify the samples in Dₖ, and weighted average was carried out on a classification result of each sample for each decision tree to calculate an error rate. If the error rate was greater than or equal to a preset threshold epsilonₖ₋₁, a decision tree Tₖ would be trained by Dₖ, the label(g) would be predicted by Tₖ according to any g, the samples with wrong classification would be put into the data set Dₖ₊₁ and then S6 would be executed. If the classification error rate was less than the preset threshold epsilonₖ₋₁, the test of the test template test_case_templat would be ended.

S6, according to all leaf nodes classified as a first class in Tₖ, all areas in which the classification label of g was predicted to be the first class by Tₖ are found in the N-dimensional space where g was located, and a union of the areas was taken. The union was denoted as Rₖ.

In this embodiment of automatic driving, all the leaf nodes classified as LOW in Tk are found in the N-dimensional space where G is located, and all the areas predicted by Tk as LOW by the category label of G are merged and marked as Rk. The category label of any vector outside Rk is NORMAL.

S7, a batch of new vectors g_new was sampled in the N-dimensional space where g is located, and a vector distribution density was kept positively correlated with a distance between g_new and a boundary of Rₖ; g_new formed a set G_new. Let k=k+1, and if k was less than a threshold of preset rounds, then Gₖ=G_new, S4 would be executed, and a next round of testing would be started; otherwise, the test of the test template test_case_template would be ended.

The vectors in the set G_new satisfied the following conditions:

(1) In order to make the new test cases approximate to the boundary as much as possible, the closer the Rₖ boundary was, the denser the vector distribution was.

(2) In order to reduce the repeated testing of similar cases, there was a certain distance between the newly sampled vector and the tested vector, and the following conditions were met:

The absolute projection value of g−g_old in the j^{th} dimension was greater than or equal to dⱼₖ, where g_old is an arbitrary vector belonging to the union of G₁, G₂, . . . , Gₖ, and dⱼₖ is the threshold of the distance between g and g_old in the j^{th} dimension in the k^{th} round.

As the number of iteration rounds increased, the accumulated vectors gradually increased. In order to reduce the amount of data calculation, dⱼₖ was set to be a gradually decreasing value, namely:

dⱼₖ=alpha*dⱼₖ₋₁

where alpha is a given normal number, 0<alpha<1.

In an embodiment of automatic driving, alpha is 0.9.

The intelligent test method of the present disclosure is applied to the automatic driving scene, which can influence the algorithm logic of automatic driving case selection, so that the case that is more likely to be tested as the junction of low and normal is selected, and the training efficiency of automatic driving in the virtual training ground is increased.

It can be understood by those skilled in the art that the above examples are only preferred examples of the present disclosure, and are not intended to limit the present disclosure. Although the present disclosure has been described in detail with reference to the above examples, it is still possible for those skilled in the art to modify the technical solutions described in the above examples or equivalently replace some of the technical features. Modifications, equivalents and substitutions made within the spirit and principle of the present disclosure shall be included in the scope of protection of the present disclosure.

What is claimed is:

1. An intelligent test method for dynamically generating a test case based on test performance of a tested system, comprising following steps:
S1, selecting a test template test_case_template containing N variables var;
S2, sampling values in a value range of each variable var and forming a sampling set Q with all of the sampled values;
S3, selecting a value from a sampling set Q corresponding to each variable to form a template variable numerical sampling vector g=(s₁, s₂, . . . , s_{N}), s₁∈Q₁, s₂∈Q₂, . . . , s_{N}∈Q_{N}, and then generating a set G_init from g;
S4, starting a k^{th} round of test, wherein when k=1, the set Gₖ=G_init; traversing each template variable numerical sampling vector in the set Gₖ, obtaining a category label(g) corresponding to each template variable numerical sampling vector g according to the test template when traversing, and obtaining a test performance data set Dₖ corresponding to the set Gₖ;
S5, determining whether k is equal to 1,
if k=1, training a decision tree Tₖ whose error rate is less than a preset threshold epsilonₖ by the test performance data set Dₖ, predicting the label(g) by the decision tree Tₖ according to any g, and putting a sample with wrong classification into a data set Dₖ₊₁;
if k>1, classifying and verifying the samples in test performance data set Dₖ by decision trees T₁, T₂, . . . , Tₖ₋₁, and carrying out weighted average on a classification result of each sample for each decision tree to calculate an error rate, if the error rate is greater than or equal to a preset threshold epsilonₖ₋₁, training a by test performance data set Dₖ, predicting the label(g) by the decision tree Tₖ according to any g, putting the samples with wrong classification into the data set Dₖ₊₁, and going to S6, if the error rate is less than the preset threshold epsilonₖ₋₁, ending testing the test template test_case_template;
S6, finding all areas in which the classification label of g is predicted to be the first class by the decision tree Tₖ in a N-dimensional space where g is located according to all leaf nodes classified as a first class in the decision tree Tₖ and taking a union of the areas, wherein the union is denoted as Rₖ;
S7, sampling a batch of new vectors g_new in the N-dimensional space where g is located, keeping a vector distribution density positively correlated with a distance between g_new and a boundary of Rₖ, forming a set G_new by the vectors g_new; letting k=k+1, if k is less than a threshold of preset rounds of testing, letting Gₖ=G_new, going to S4, and starting a next round of testing, and if k is greater and equal to the threshold of preset rounds of testing, ending testing the test template test_case_template.

2. The intelligent test method for dynamically generating a test case according to test performance of a tested system according to claim 1, wherein step S4 further comprises in order to obtain the data set Dₖ corresponding to the set Gₖ, first generating a copy of the test template test_case_template, replacing the variable varᵢ in the copy by sᵢ in g, wherein the replaced copy of the test template is defined as a test case and denoted as H(g); testing the tested system with H(g) to obtain a test score(g), and providing a two-class category label(g) for the test case H(g) according to the test score(g); and finally, putting a binary group (g, label(g)) into the test performance data set Dₖ.

3. The intelligent test method for dynamically generating a test case according to test performance of a tested system according to claim 1, wherein said keeping a vector distribution density positively correlated with a distance between g_new and a boundary of the area R in S7 comprises the vector in G_new satisfying following conditions:
(1) the closer to the boundary of Rₖ is, the denser the vector distribution is; and
(2) a certain distance exists between a newly sampled vector and a tested vector.

4. The intelligent test method for dynamically generating a test case according to test performance of a tested system according to claim 3, wherein the distance between the newly sampled vector g_new and the tested vector g_old satisfies:
an absolute value of projection of g_new-g_old in a j dimension is greater than or equal to dⱼₖ, where g_old is an arbitrary vector belonging to a union of G₁, G₂, . . . , Gₖ, and dⱼₖ is a threshold of a distance between g_new and g_old in the j dimension in a k^{th} round.

5. The intelligent test method for dynamically generating a test case according to test performance of a tested system according to claim 1, wherein the category label(g) is LOW or NORMAL, the category label(g) being LOW when the test score(g) is less than a preset score threshold, and the category label(g) is NORMAL when the test score(g) is greater than or equal to the preset score threshold.

6. The intelligent test method for dynamically generating a test case according to test performance of a tested system according to claim 4, wherein dik satisfies following condition:
dⱼₖ=alpha*dⱼₖ₋₁
where alpha is a given normal number, 0<alpha<1.
